(19) United States
(12) Patent Application Publication
(10) Pub. No.: US 2014/0336094 A1
(43) Pub. Date: Nov. 13, 2014

(54) CLEANING COMPOSITION AND METHOD OF FORMING THE SAME

(71) Applicant: BASF SE, Ludwigshafen (DE)

(72) Inventor: Stephen F. Gross, Rockwood, MI (US)

(21) Appl. No.: 14/264,814

(22) Filed: Apr. 29, 2014

Related U.S. Application Data
(60) Provisional application No. 61/820,928, filed on May 8, 2013.

(51) Int. Cl. C11D 1/83

(52) U.S. Cl. CPC C11D 1/83
USPC 510/218

(57) ABSTRACT

A cleaning composition, useful for dishwashing, comprises about 1 to about 35 weight percent (wt. %) of an anionic surfactant, about 1 to about 35 wt. % of a nonionic surfactant, and at least about 1 wt. % of lactic acid. The anionic and nonionic surfactants are present in a combined amount of at least about 8 wt. %. Each of the weight percentages is based on 100 parts by weight of the composition. The composition has a pH of no greater than about 4. A method of forming the composition comprises the steps of combining the anionic and nonionic surfactants to form a first solution, and combining a supplemental acid different from lactic acid with the first solution to form a second solution. The second solution has a pH of no greater than about 5. The method further comprises the step of combining the lactic acid and second solution to form the composition.

### CROSS REFERENCE TO RELATED APPLICATIONS

This application claims priority to and all the advantages of U.S. Provisional Patent Application No. 61/820,928, filed on May 8, 2013, the content of which is incorporated by reference.

### FIELD OF THE INVENTION

The present invention generally relates to a cleaning composition useful for dishwashing, and more specifically to a cleaning composition comprising an anionic surfactant, a nonionic surfactant, and lactic acid, and to a method of forming the cleaning composition.

### DESCRIPTION OF THE RELATED ART

Cleaning compositions, such as those used for manual (or hand) dishwashing, are understood in the art. Dishwashing liquids, also known as “dishwashing soaps” or “dish soaps”, are detergents used to assist in dishwashing. Such cleaning compositions are usually highly-foaming mixtures of surfactants with low skin irritation, and are primarily used for hand washing of glasses, plates, cutlery, and cooking utensils in a sink, tub, or bowl. While conventional formulations are commercially available, there remains an opportunity to provide improved cleaning compositions for dishwashing.

### SUMMARY OF THE INVENTION AND ADVANTAGES

A cleaning composition is disclosed. The cleaning composition comprises about 1 to about 35 weight percent (wt. %) of an anionic surfactant. The cleaning composition further comprises about 1 to about 35 wt. % of a nonionic surfactant. The cleaning composition yet further comprises at least about 1 wt. % of lactic acid. The anionic and nonionic surfactants are present in a combined amount of at least about 8 wt. %. Each of the weight percentages is based on 100 parts by weight of the cleaning composition. The cleaning composition has a pH of no greater than about 4.

A method of forming the cleaning composition is also disclosed. The method comprises the step of combining the anionic surfactant and the nonionic surfactant to form a first solution. The method further comprises the step of combining a supplemental acid different from the lactic acid with the first solution to form a second solution. The second solution has a pH of no greater than about 5. The method yet further comprises the step of combining the lactic acid and the second solution to form the cleaning composition.

The cleaning composition is useful for dishwashing, and is especially useful for manual (or hand) dishwashing. The cleaning composition has excellent cleaning performance, such as increased dishwashing performance in terms of plate count (e.g. according to ASTM D4009, Method A, Soil B) without increasing surfactant actives relative to conventional cleaning compositions. Among other benefits, this provides for increased performance at equal cost, or equal performance at lower cost, relative to conventional cleaning compositions.

### DETAILED DESCRIPTION OF THE INVENTION

A cleaning composition is disclosed. The cleaning composition is useful for dishwashing, and is especially useful for manual (or hand) dishwashing. The cleaning composition is typically in the form of a liquid, and is generally high sudsing and foaming in nature, much like conventional liquid hand dishwashing detergents. The cleaning composition may be referred to in the art as a light duty liquid (i.e., “LDL”) detergent. Water and/or another conventional solvent/diluent can be added or removed to/from the cleaning composition to change the viscosity and/or % actives of the cleaning composition.

The cleaning composition can be used on a variety of different ware surfaces, and the cleaning composition is not limited to a particular one. Examples of such ware surfaces include those found with cookware, bakeware, tableware, dishware, flatware, and glassware. As used herein “dishware” generally means a surface such as dishes, glasses, pots, pans, baking dishes and flatware made from ceramic, china, metal, glass, plastic (e.g. polyethylene, polypropylene, polystyrene, etc.) and wood. The cleaning composition is not limited to any particular soil or ware surface.

In various embodiments described herein, the cleaning composition comprises an anionic surfactant, a nonionic surfactant, and lactic acid. The surfactant components are useful for dissolving and/or emulsifying certain types of soils. The surfactant components are also useful for surface wetting which helps deliver the cleaning composition to the ware surface(s). The lactic acid useful as an antibacterial active, especially in embodiments of the cleaning composition which are free of a conventional antibacterial component. In further embodiments, the cleaning composition consists essentially of the anionic surfactant, the nonionic surfactant, and the lactic acid. The cleaning composition can also include one or more additional components (or additives) as described further below.

### Surfactant Components

Referring now to the anionic surfactant, the anionic surfactant may be referred to in the art as a “primary” surfactant of the cleaning composition. The anionic surfactant can include any of the surfactants commonly classified as anionic surfactants. These surfactants can include the alkali metal, ammonium, and magnesium salts of the alpha olefin sulfonates, alkyl sulfonates, alkyl aryl sulfonates, alkyl aryl ether sulfates, alkyl sulfates, alkyl ether sulfates, sulfated alcohols, and sulfated alcohol ethoxylates, taurates, petroleum sulfonates, alkyl naphthalene sulfonates, alkyl sarcosinates, and the alkyl sulfosuccinates in which the alkyl group is a long chain 8 to 22, more typically 10 to 18, carbon atom group and the aryl group is typically phenyl or naphthyl.

Typical anionic surfactants which fall within the above description include sodium lauryl sulfonate, ammonium lauryl sulfonate, ammonium lauryl sulfate, dodecyl benzene sulfonate (i.e., “LAS” or “LAS acid”), sodium lauryl sulfate (i.e., “SLS”), sodium laureth sulfate, sodium lauryl ether sulfate (i.e., “SLES”), sodium lauryl myristyl sulfate, diethanolamine lauryl sulfate, ammonium salts of sulfated alcohol ethoxylates, sodium cocoyl isethionate, sodium N-methyl-N-oleyl taurate, sodium N-methyl-N-cocoyl taurate, triethanolamine lauryl sulfate, disodium monooleamide PEG-2 sulfosuccinate, sodium xylene sulfonate, petroleum sulfonates sodium salt, alkyl naphthalene sodium sulfonates, sodium lauroyl sarcosinate, and sodium alkyl sulfosuccinate. In specific embodiments, the anionic surfactant utilized for the cleaning composition comprises, consists essentially of, or consists of, SLS.

In various embodiments, the anionic surfactant is classified as a fatty alcohol sulfate (i.e., a “FAS”). In certain embodiments, the anionic surfactant is a FAS having the general formula I below:

R₁OSO₃M (I)

wherein R₁ is generally an alkyl group containing from 10 to 11 carbon atoms, and M is generally selected from the group consisting of alkali metals, alkaline earth metals, and mixtures thereof.

If utilized as (or in) the anionic surfactant, the fatty alcohol sulfate may be prepared in a manner understood in the art, such as by reaction of the corresponding alcohol component with a sulfating agent, more typically with a sulfur trioxide or chlorosulfonic acid, and subsequent neutralization, generally with alkali bases, ammonium bases or alkyl- or hydroxyalkyl-substituted ammonium bases. In one embodiment utilizing FAS, the FAS is prepared by mixing sodium lauryl sulfate having 12 carbon atoms as its primary carbon chain, with sodium n-decyl sulfate having 10 carbon atoms as its primary carbon chain in a wt. % actives ratio of from about 5:1 to about 1:5, and more typically about 1:1, respectively.

Non-limiting examples of suitable anionic surfactants are commercially available from BASF Corporation of Florham Park, N.J., under the trademark STANDAPOL®, such as STANDAPOL® WAQ-LCK, and under the trade name TEXAPON®, such as TEXAPON® N 70. It is to be appreciated that the anionic surfactant can include a mixture of two or more of the anionic surfactants described herein. Further suitable anionic surfactants, for purposes of various embodiments of the present invention, are described below.

The anionic surfactant is typically present in the cleaning composition in an amount of from about 1 to about 35, about 1 to about 30, about 1 to about 25, about 5 to about 20, about 10 to about 15, about 11 to about 13, or about 12.5, wt. %, each based on 100 parts by weight of the cleaning composition, or any range between the lowest and highest of these values. Typically, the amounts described herein are based on the assumption that the anionic surfactant includes 100% actives. As such, if the anionic surfactant is aqueous, for example, the amounts can be adjusted accordingly to compensate for % actives dilution.

Optionally, in certain embodiments of the present invention, the cleaning composition further comprises a second anionic surfactant different from, and in addition to, the (first) anionic surfactant described above. These embodiments can be useful for supplementing the first anionic surfactant and/or for adjusting viscosity of the cleaning composition. As introduced above, the cleaning composition can include two or more different anionic surfactants.

In certain embodiments, the second anionic surfactant may be characterized in the art as a hydrotrope. If utilized, the hydrotrope is useful for increasing stability of the cleaning composition, which also relates to cloud point (or compatibility index) of the cleaning composition. The hydrotrope may also be useful for adjusting viscosity of the cleaning composition. If utilized, various types of hydrotropes can be included in the cleaning composition, even those not generally characterized as anionic surfactants. Examples of suitable hydrotropes include sulfonates, such as xylene sulfonates (e.g. sodium xylene sulfonate), cumene sulfonates, and dihexyl sodium sulfonate; alkyl sulfates, such as sodium alkyl sulfates, e.g. sodium octyl sulfate; urea; isopropanol and other alcohols; alcohol alkoxylates; glycols, such as hexylene glycol and propylene glycol; and those hydrotropes described in U.S. Pat. No. 3,563,901 to Crotty and U.S. Pat. No. 4,443,270 to Baird et al., the disclosures of which are incorporated herein by reference in their entirety. Non-limiting examples of suitable hydrotropes are commercially available from BASF Corporation, under the trade name TEXAPON®, such as TEXAPON® 842 and TEXAPON® 842 UP. In specific embodiments, the second anionic surfactant utilized for the cleaning composition comprises, consists essentially of, or consists of, a sodium alkyl sulfate.

If utilized in the cleaning composition, the second anionic surfactant (or hydrotrope) can be present in various amounts. In certain embodiments, the second anionic surfactant (or hydrotrope) is present in the cleaning composition in an amount of from about 1 to about 10, about 1 to about 7.5, about 2 to about 5, or about 3.5, wt. %, each based on 100 parts by weight of the cleaning composition, or any range between the lowest and highest of these values. Typically, the amounts described herein are based on the assumption that the second anionic surfactant (or hydrotrope) includes 100% actives. As such, if the second anionic surfactant (or hydrotrope) is aqueous, for example, the amounts can be adjusted accordingly to compensate for % actives dilution.

Referring now to the nonionic surfactant, the nonionic surfactant can include any of the surfactants commonly classified as nonionic surfactants. The nonionic surfactant may also be referred to in the art as a “primary” surfactant of the cleaning composition (along with the anionic surfactant described above). Suitable nonionic surfactants can include an alkyl polyglycoside (i.e., an “APG”), such as APGs having the general formula II:

R₂O(R₃O)_{b}(Z)ₐ (II)

wherein R₂ is a generally monovalent organic radical having from about 6 to about 30 carbon atoms, R₃ is generally a divalent alkylene radical having from 2 to 4 carbon atoms, Z is generally a saccharide residue having 5 or 6 carbon atoms, b is generally a number having a value of from 0 to about 12, and a is generally a number having a value of from 1 to about 6. Other types of APGs can also be utilized.

Such APGs are commercially available, for example, as GLUCOPON® or PLANTAREN® surfactants from BASF Corporation. Examples of such surfactants include, but are not limited, to: GLUCOPON® 225, GLUCOPON® 425, GLUCOPON® 625, APG® 325, GLUCOPON® 600, GLUCOPON® 600 UP, PLANTAREN® 2000, and PLANTAREN® 1300.

Other examples include APG surfactant compositions which are comprised of mixtures of compounds of formula II wherein: Z represents a moiety derived from a reducing saccharide containing 5 or 6 carbon atoms; a is a number having a value from 1 to about 6; b is zero; and R1 is an alkyl radical having from 8 to 20 carbon atoms. The compositions are characterized in that they have increased surfactant properties and an HLB in the range of about 10 to about 16 and a non-Flory distribution of glycosides, which is comprised of a mixture of an alkyl monoglycoside and a mixture of APGs having varying degrees of polymerization of 2 and higher in progressively decreasing amounts, in which the amount by weight of polyglycoside having a degree of polymerization of 2, or mixtures thereof with the polyglycoside having a degree of polymerization of 3, predominate in relation to the amount of monoglycoside, the composition having an average degree of polymerization of about 1.8 to about 3. Such compositions, also known as “peaked” APGs, can be prepared by separation of the monoglycoside from the original reaction mixture of alkyl monoglycoside and APGs after removal of the alcohol. This separation may be carried out by molecular distillation and normally results in the removal of about 70-95% by weight of the alkyl monoglycosides. After removal of the alkyl monoglycosides, the relative distribution of the various components, mono- and poly-glycosides, in the resulting product changes and the concentration in the product of the polyglycosides relative to the monoglycoside increases as well as the concentration of individual polyglycosides to the total, i.e. DP2 and DP3 fractions in relation to the sum of all DP fractions. Such compositions are disclosed in U.S. Pat. No. 5,266,690 to McCurry, Jr. et al., the disclosure of which is incorporated herein by reference in its entirety.

Other APGs which can be used are those in which the alkyl moiety contains from 6 to 18 carbon atoms in which the average carbon chain length of the composition is from about 9 to about 14 comprising a mixture of two or more of at least binary components of APGs, wherein each binary component is present in the mixture in relation to its average carbon chain length in an amount effective to provide the surfactant composition with the average carbon chain length of about 9 to about 14 and wherein at least one, or both binary components, comprise a Flory distribution of polyglycosides derived from an acid-catalyzed reaction of an alcohol containing 6 to 20 carbon atoms and a suitable saccharide from which excess alcohol has been separated. In one embodiment, the APG is of the type in general formula II wherein: R2 is a monovalent organic radical having from 8 to 16 carbon atoms; Z is a saccharide residue having 5 or 6 carbon atoms; b is zero; and a is a number having a value of 1.55.

In various embodiments, the nonionic surfactant utilized for the cleaning composition comprises, consists essentially of, or consists of, an APG. In specific embodiments, the nonionic surfactant utilized for the cleaning composition comprises, consists essentially of, or consists of, lauryl/myristyl glucoside. It is to be appreciated that the anionic surfactant can include a mixture of two or more of the nonionic surfactants described herein. Further suitable nonionic surfactants, for purposes of various embodiments of the present invention, are described below.

The nonionic surfactant is typically present in the cleaning composition in an amount of from about 1 to about 35, about 1 to about 30, about 1 to about 25, about 5 to about 20, about 10 to about 15, about 11 to about 13, or about 12.5, wt. %, each based on 100 parts by weight of the cleaning composition, or any range between the lowest and highest of these values. Typically, the amounts described herein are based on the assumption that the nonionic surfactant includes 100% actives. As such, if the nonionic surfactant is aqueous, for example, the amounts can be adjusted accordingly to compensate for % actives dilution. In specific embodiments, the anionic and nonionic surfactants are present in the cleaning composition in a wt. % ratio of about 1:1. Other ratios may also be utilized.

The anionic and nonionic (i.e., primary) surfactants are present in the cleaning composition in a combined amount of at least about 8, at least about 9, or at least about 10, wt. %. The surfactants can be in various ratios relative to one another, provided by are individually present within their respective ranges described above. In various embodiments, the anionic and nonionic surfactants are present in the cleaning composition in a combined amount of at least about 8, at least about 9, at least about 10, at least about 12.5, at least about 15, at least about 17.5, or at least about 20, wt. %, each based on 100 parts by weight of the cleaning composition, or any range between the lowest and highest of these values.

Optionally, in various embodiments, the cleaning composition further comprises a supplemental surfactant different from the nonionic and anionic surfactants described above. The supplemental surfactant can comprise any type of conventional surfactant understood in the art. The supplemental surfactant may also be referred to in the art as a “secondary” surfactant or a co-surfactant, and is useful for a variety of purposes, such as for boosting cleaning performance of the cleaning composition. If utilized, the supplemental surfactant is typically selected from the group of nonionic surfactants, anionic surfactants, amphoteric surfactants, cationic surfactants, and ionic surfactants. It is to be appreciated that other types of surfactants can also be used.

In certain embodiments, the supplemental surfactant is an amphoteric surfactant. Suitable amphoteric surfactants include the betaines, the sultaines, the imidazoline derivatives and the like. Typical amphoteric surfactants include ricinoleamidopropyl betaine, cocamidopropyl betaine, oleyl betaine, stearyl betaine, stearyl amphocarboxy glycinate, sodium lauraminopropionate, cocoamidopropyl hydroxy sultaine, disodium lauryliminodipropionate, tallowiminodipropionate, cocoampho-carboxy glycinate, cocoimidazoline carboxylate, lauric imidazoline monocarboxylate, lauric imidazoline dicarboxylate, lauric myristic betaine, cocoamidosulfobetaine, alkylamidophospho betaine and the like.

Examples of suitable betaines include alkyl betaines, alkylamidobetaine, amidazoliniumbetaine, sulfobetaine (INCI Sultaines) as well as the phosphobetaine. In specific embodiments, the supplemental surfactant comprises, consists essentially of, or consists of, a cocoamido alkyl betaine, such as a cocoamido propyl betaine.

Further examples of suitable surfactants include amine oxides, especially coco dimethyl amine oxide or coco amido propyl dimethyl amine oxide Amine oxide may have a linear or mid-branched alkyl moiety. Mixtures of two of more of the aforementioned surfactants may be utilized. If utilized in the cleaning composition, a betaine and/or an amine oxide is/are especially useful as a foam stabilizer. In other words, these components generally make foam last longer during use of the cleaning composition. The supplemental surfactant(s) described herein can also be useful for other purposes, such as for cutting grease during use of the cleaning composition.

Nonionic surfactants, suitable as the supplemental surfactant, include block copolymers such as polyalkylene oxide surfactants (also known as polyoxyalkylene surfactants or polyalkylene glycol surfactants). Suitable polyalkylene oxide surfactants include polyoxypropylene surfactants and polyoxyethylene glycol surfactants. Suitable surfactants of this type are synthetic organic polyoxypropylene (PO)-polyoxyethylene (EO) block copolymers.

These surfactants generally comprise a di-block polymer comprising an EO block and a PO block, a center block of polyoxypropylene units (PO), and having blocks of polyoxyethylene grafted onto the polyoxypropylene unit or a center block of EO with attached PO blocks. Further, this surfactant can have further blocks of either polyoxyethylene or polyoxypropylene in the molecules. The surfactant may also include butylene oxide (BO) blocks, and can include random incorporations of two or three alkylene oxides, e.g. EO/PO/BO, EO/PO/PO, EO/EO/PO, etc. Such surfactants may be referred to in the art as “heteric” block surfactants.

In certain embodiments, the supplemental surfactant comprises an ethylene oxide-propylene oxide (EO/PO) block copolymer and/or a reverse EO/PO block copolymer, i.e., a PO/EO block copolymer. Specific examples of suitable block copolymers include: straight block polymeric glycols obtained, for example, by the addition of ethylene oxide (EO) on a condensation product of propylene oxide (PO) with propylene glycol; and reverse block copolymers obtained, for example, by adding ethylene oxide to ethylene glycol to provide a hydrophile of designated molecular weight, and adding polypropylene oxide to obtain hydrophobic blocks on the outside of the molecule. Reversing the hydrophobic and hydrophilic blocks of the copolymer PO/EO/PO creates surfactants similar to the regular EO/PO/EO block copolymers. These block copolymers may also be referred to in the art as polaxamers or triblock copolymers.

Additional nonionic surfactants, suitable for purposes of the present invention, include alcohol alkoxylates. Suitable alcohol alkoxylates include linear alcohol ethoxylates. Additional alcohol alkoxylates include alkylphenol ethoxylates, branched alcohol ethoxylates, secondary alcohol ethoxylates, castor oil ethoxylates, alkylamine ethoxylates (also known as alkoxylated alkyl amines), tallow amine ethoxylates, fatty acid ethoxylates, sorbital oleate ethoxylates, end-capped ethoxylates, or combinations thereof. Further nonionic surfactants include amides such as fatty alkanolamides, alkyldiethanolamides, coconut diethanolamide, lauramide diethanolamide, cocoamide diethanolamide, polyethylene glycol cocoamide, oleic diethanolamide, or combinations thereof. Yet further nonionic surfactants include polyalkoxylated aliphatic base, polyalkoxylated amide, glycol esters, glycerol esters, amine oxides, phosphate esters, alcohol phosphate, fatty triglycerides, fatty triglyceride esters, alkyl ether phosphate, alkyl esters, alkyl phenol ethoxylate phosphate esters, alkyl polysaccharides, block copolymers, alkyl polyglucocides, or combinations thereof.

Further non-limiting examples of suitable surfactant components, for purposes of the present invention, are commercially available from BASF Corporation, under the trade name LUTENSOL®, such as LUTENSOL® XP 80, LUTENSOL® XL 80, LUTENSOL® TO 8, and LUTENSOL® GD 70; under the trade name TETRONIC®, such as TETRONIC® 304; under the trade name of PLURONIC®, such as PLURONIC® 25R2, PLURONIC® 17R2, and PLURONIC® 25R4; under the trade name DEHYPON®, such as DEHYPON® LS-36 and DEHYPON® LS-54; under the trade name PLURAFAC®, such as PLURAFAC® LF 900, PLURAFAC® SLF 180, PLURAFAC® RA-40, and PLURAFAC® LF 711; under the trade name of PLANTOPON®, such as PLANTAPON® 611 L; as well as under the trade name LUTENSIT®, such as LUTENSIT® AS 2230. Additional examples, commercially available from BASF Corporation, include the DEHYTON® range of surfactants, which generally consists of surfactants of amphoteric (betaines and amphoacetates) or nonionic structure (aminoxides types). Specific examples of suitable DEHYTON® surfactants include DEHYTON® PK 45 and DEHYTON® CAW, surfactants. In these embodiments, the supplemental surfactant may also be useful as a foam stabilizer.

Further non-limiting examples are commercially available from Huntsman, under the trade names of EMPILAN®, such EMPILAN® KB and EMPILAN® KC; SURFONIC® L12; TERIC® 12A; and ECOTERIC®, such as ECOTERIC® B30 and ECOTERIC® B35. Further non-limiting examples are commercially available from Croda, under the trade name of NatSurf™, such as NatSurf™ 265. Further non-limiting examples are commercially available from Stepan, under the trade name of BIO-SOFT®, including the BIO-SOFT® N1, N23, and N91 series. Yet further non-limiting examples are commercially available from Air Products, under the trade names of NONIDET® and TOMADOL®. Combinations of two or more different surfactants may be used in the cleaning composition.

If utilized in the cleaning composition, the supplemental surfactant can be present in various amounts. In certain embodiments, the supplemental surfactant is present in the cleaning composition in an amount of from about 1 to about 10, about 1 to about 7.5, about 1 to about 5, or about 1 to about 3, wt. %, each based on 100 parts by weight of the cleaning composition, or any range between the lowest and highest of these values. Typically, the amounts described herein are based on the assumption that the supplemental surfactant includes 100% actives. As such, if the supplemental surfactant is aqueous, for example, the amounts can be adjusted accordingly to compensate for % actives dilution.

### Acid Component(s)

The lactic acid may also be referred to in the art as milk acid or 2-hydroxypropanoic acid. A non-limiting example of a suitable lactic acid is commercially available from Purac of Lincolnshire, Ill., under the trademark PURAC®, such as PURAC® Sanilac. It is to be appreciated that other suitable lactic acids are commercially available from other sources.

The lactic acid is typically present in the cleaning composition in an amount of at least about 1, at least about 1.5, at least about 2, at least about 2.5, or of from about 1 to about 5, about 2 to about 5, about 2 to about 4, about 2 to about 3, or about 2.5, wt. %, each based on 100 parts by weight of the cleaning composition, or any range between the lowest and highest of these values. Typically, the amounts described herein are based on the assumption that the lactic acid includes 100% actives. As such, if the lactic acid is aqueous, for example, the amounts can be adjusted accordingly to compensate for % actives dilution. The lactic acid is useful as an antibacterial (or antimicrobial) agent. The lactic acid may also be useful as a preservative. In related embodiments, the lactic acid is utilized in an amount sufficient such that the cleaning composition has a pH of no greater than about 7, no greater than about 6, no greater than about 5, no greater than about 4, no greater than about 3, or no greater than about 2, or any range therebetween.

In various embodiments, the cleaning composition further comprises a supplemental acid different from the lactic acid. The supplemental acid is useful for lowering pH of the cleaning composition. In general, the supplemental is less costly than the lactic acid, which improves the overall cost of the cleaning composition. The supplemental acid can be of any type, including inorganic and organic acids. Utilizing the acid component(s) allows for the cleaning composition to be provided without preservatives.

Examples of suitable inorganic acids include: sulfuric acid, phosphoric acid, potassium dihydrogenphosphate, sodium dihydrogenphosphate, sodium sulfite, potassium sulfite, sodium pyrosulfite (sodium metabisulfite), potassium pyrosulfite (potassium metabisulfite), acid sodium hexametaphosphate, acid potassium hexametaphosphate, acid sodium pyrophosphate, acid potassium pyrophosphate, hydrochloric acid, and sulfamic acid. In specific embodiments utilizing the supplemental acid, the cleaning composition comprises sulfuric acid in addition to the lactic acid.

Examples of suitable organic acids include those which include at least one carbon atom, and include at least one carboxyl group in its structure. Specific examples include water soluble organic acids which contain from 1 to about 6 carbon atoms, and at least one carboxyl group as noted and further useful organic acids include: linear aliphatic acids such as formic acid, acetic acid, propionic acid, butyric acid and valeric acid; dicarboxylic acids such as oxalic acid, malonic acid, succinic acid, glutaric acid, adipic acid, pimelic acid, fumaric acid and maleic acid; acidic amino acids such as glutamic acid and aspartic acid; and hydroxy acids such as glycolic acid, lactic acid, hydroxyacrylic acid, alpha-hydroxybutyric acid, glyceric acid, tartronic acid, malic acid, tartaric acid and citric acid, as well as acid salts of these organic acids.

If utilized in the cleaning composition, the supplemental acid is typically present in the cleaning composition in an amount of at least about 1, at least about 1.5, at least about 2, at least about 2.5, or of from about 1 to about 5, about 2 to about 5, about 2 to about 4, about 2 to about 3, or about 2.5, wt. %, each based on 100 parts by weight of the cleaning composition, or any range between the lowest and highest of these values. Typically, the amounts described herein are based on the assumption that the supplemental acid includes 100% actives. As such, if the supplemental acid is aqueous, for example, the amounts can be adjusted accordingly to compensate for % actives dilution. In related embodiments, the supplemental acid is utilized in an amount sufficient such that the cleaning composition has a pH of no greater than about 7, no greater than about 6, no greater than about 5, or no greater than about 4, or any range therebetween, prior to incorporation/presence of the lactic acid component.

In various embodiments described further below, the supplemental acid is utilized to form the cleaning composition prior to inclusion the lactic acid. These embodiments are useful for preventing the lactic acid from prematurely reacting with another component (e.g. a base, a contaminant, etc.), which may be imparted by one or more of the surfactant components. In this way, the supplemental acid can be used to react with such components first (if present), which can be beneficial in a cost sense (assuming the lactic acid is more costly than the supplemental acid). The supplemental acid is also useful for counteracting (initial) alkalinity of the cleaning composition which may be imparted by one or more of the surfactant components. For example, a sufficient amount of the supplemental acid can be utilized during formation of the cleaning composition to swing the cleaning composition from alkaline to acidic, and then a sufficient amount of lactic acid can be used to obtain a final (acidic) pH of the cleaning composition.

### Diluent Component(s)

The cleaning composition typically comprises at least one diluent. Examples of suitable diluents include water, one or more alcohols, or combinations thereof. The diluent is useful as a filler component (e.g. for cost purposes) as well as for adjusting viscosity of the cleaning composition.

The water can be of various types. In certain embodiments, the water is demineralized. The water is present in the composition in various amounts, depending on the embodiment. The water can be added to the composition as a separate component. However, some of the water can also be imparted by one of the other components, such as by one of more of the surfactant components and/or the lactic acid, if aqueous in nature.

The amount of water can be adjusted based on the desired form of the composition. As such, the present invention is not limited to a particular amount of water. For example, the cleaning composition can be formulated as a “low”, “medium”, or “high” actives composition with decreasing amounts of water, respectively, where the actives comprise at least the surfactant components of the cleaning composition.

The water can be present in the cleaning composition in various amounts. In certain embodiments, the water is present in the cleaning composition in an amount of from about 40 to about 90, about 50 to about 80, or about 65 to about 75, wt. %, each based on 100 parts by weight of the cleaning composition, or any range between the lowest and highest of these values.

In certain embodiments, the cleaning composition further comprises an alcohol. Examples of suitable alcohols include n-butanol, iso-butanol, 2-ethyl hexanol, 2-propyl heptanol, butyl glycol, butyl diethyleneglycol, butyl triethyleneglycol, butyl propyleneglycol, butyl dipropyleneglycol, butyl tripropyleneglycol, methyl diglycol, methyl triglycol, methyldipropyleneglycol, methyldipropyleneglycol, methanol, ethanol, and propanol (e.g. 1-propanol and/or isopropyl alcohol). If utilized in the cleaning composition, the alcohol is typically of the type classified in the art as a “water-soluble” alcohol. Such alcohols, if utilized to form the cleaning composition, are especially useful for adjusting viscosity of the cleaning composition. In specific embodiments, the alcohol is ethanol (i.e., “EtOH”). As introduced above, mixtures of two or more different alcohols can be utilized in the cleaning composition.

If utilized in the cleaning composition, the alcohol can be present in various amounts. In certain embodiments, the alcohol is present in the cleaning composition in an amount of from about 1 to about 10, about 1 to about 7.5, about 2 to about 5, or about 3.5, wt. %, each based on 100 parts by weight of the cleaning composition, or any range between the lowest and highest of these values. Adjusting the amount of alcohol, if utilized, can also be useful for changing the actives dilution (as like described above with water).

### Additive Component(s)

Optionally, the cleaning composition may include one or more additives. Any type of additive can be utilized, especially additives which are conventionally used in dishwashing applications. Examples of suitable additives include supplemental builder components such as metal citrates, enzymes, salts, dispersants, polymers, soil release polymers, cleaning polymers (such as ethoxylated polyethylene imine cleaning polymers), complexing agents, fragrances, preservatives, fillers, inorganic extenders, formulation auxiliaries, solubility improvers, dyes, corrosion inhibitors, peroxide stabilizers, electrolytes, soaps, detergents, solvents such as ethylene glycol, 2-butoxyethanol, butyldiglycol, alkyl glycol ethers, and isopropanol, perfumes, oils, oxidizing agents such as perborates, dichloroisocyanurates, interface-active ethyleneoxy adducts, and combinations thereof. The cleaning composition is not limited to any particular type of additive, and if utilized in the cleaning composition, the additive (or additives) can be present in various amounts understood in the art.

### Physical Properties of the Cleaning Composition

As introduced above, the cleaning composition is generally acidic in nature based on the presence of the acid component(s). Specifically, the cleaning composition typically has a pH of no greater than about 4, of no greater than about 3.5, or no greater than about 3, or a pH of from about 1 to about 4, about 2 to about 4, about 2.5 to about 3.5, about 2.8 to about 3.5, about 2.8 to about 3.2, or about 3. The pH of cleaning composition can be determined by conventional methods understood in the art.

The pH of the cleaning composition is generally imparted by at least the lactic acid, and if present, supplemental acid component as well. The acidic nature of the cleaning composition allows for the exclusion of (other) antibacterial components, as well as provides some degree of cleaning efficacy for the cleaning composition.

As introduced above, the cleaning composition is generally in the form of a liquid. In various embodiments, the cleaning composition has a viscosity of from about 100 to about 5000, about 250 to about 4000, about 500 to about 3000, about 500 to about 2000, about 750 to about 2500, about 1000 to about 2500, about 1000 to about 2000, or about 500, about 800, about 1000, about 1250, or about 1500, millipascal-second (mPa·s) at 23° C. Viscosity of the cleaning composition can be determined by conventional methods understood in the art.

### Cleaning/Foaming Efficacy of the Cleaning Composition

Without being bound or limited by any particular theory, it is believed that a synergy exists between the surfactant components and the lactic acid of the cleaning composition. Specifically, the combination of components provides for increases plate washing capability relative to conventional cleaning composition. It is believed that this is especially true in instances where an APG is utilized as the/a nonionic surfactant in conjunction with the lactic acid.

The number of plates is determined via a plate test, such as by ASTM D4009, Method A, Soil B. Typically, the cleaning composition provides for at least about 1, at least about 2, at least about 3, at least about 4, at least about 5, at least about 6, at least about 7, at least about 8, at least about 9, at least about 10, at least about 11, at least about 12, at least about 13, at least about 14, at least about 15, or from about 2 to about 20, about 5 to about 15, about 7 to about 9, about 9 to about 15, or about 10 to about 13, plates, or any number of plates therebetween. Further properties can be appreciated with reference to the Example section below. The number of plates generally increases as the total amount of actives present in the cleaning composition is increased. As such, the cleaning composition can be formulated and testing via routine experimentation to achieve a desired foaming or cleaning profile.

### Miscellaneous

Further examples of suitable alkyl polyglycosides (APGs), fatty alcohol sulfates (FASs), and/or other surfactants, for purposes of the present invention, are described in U.S. Pat. No. 5,773,406 to Gross, the disclosure of which is incorporated herein by reference in its entirety. Further examples of suitable surfactants and/or additional optional components, for purposes of the present invention, are described in U.S. Pat. No. 6,087,320 to Urfer et al.; U.S. Pat. No. 7,186,675 to Meine et al.; U.S. Pat. No. 7,348,302 to Smith; U.S. Pat. No. 7,666,826 to Smith et al.; U.S. Pat. No. 7,745,384 to Perry et al.; U.S. Pat. No. 7,998,918 to Rong et al.; U.S. Pat. No. 8,232,236 to Jaynes et al; and U.S. Pat. No. 8,283,304 to Saint Victor; the disclosures of which are incorporated herein by reference in their entirety. Yet further examples of suitable surfactants and/or additional optional components, for purposes of the present invention, are described in US Pat. App. Pub. No. 2010/0197553 to Barnabas et al., the disclosure of which is incorporated herein by reference in its entirety.

In certain embodiments, the cleaning composition is substantially free of an antibacterial component. In addition, or alternatively, the cleaning composition may substantially be free of a preservative. Such components are generally understood in the art. For example, triclosan and PCMX are common antibacterial components. Such components are generally not necessary in the invention cleaning composition based on its pH, which is imparted by presence of the lactic acid. Should an antibacterial component (and/or preservative) be present in the cleaning composition, the level of antibacterial component in the cleaning composition is typically less than about 0.5, less than about 0.1, or less than about 0.01, wt. %, each based on 100 parts by weight of the cleaning composition, or any range between the lowest and highest of these values. In certain embodiments, the cleaning composition completely excludes an antibacterial component (and/or preservative). It is to be appreciated that the lactic acid is not included in this exclusion.

In certain embodiments, the cleaning composition is substantially free of phosphorus-containing compounds, making the cleaning composition more environmentally acceptable. Phosphorus-free refers to a composition, mixture, or ingredients to which phosphorus-containing compounds are not added. Should phosphorus-containing compounds be present through contamination of a phosphorus-free composition, mixture, or ingredient, the level of phosphorus-containing compounds in the resulting cleaning composition is typically less than about 0.5, less than about 0.1, or less than about 0.01, wt. %, each based on 100 parts by weight of the cleaning composition, or any range between the lowest and highest of these values. In various embodiments, the cleaning composition is free of phosphorus-containing compounds.

In various embodiments, the cleaning composition is free of a chlorine-containing component. Examples of components containing chlorine include chlorine bleaches, which generally belong to a group of strong oxidizing agents, all of which have one or more chlorine atoms in their molecule. Specific examples of chlorine bleaches used in the art include chlorinated isocyanurates, chlorinated trisodium phosphate, hypochlorite, and sodium hypochlorite. By free of a chlorine-containing component, it is generally meant that the cleaning composition is free of a purposefully added component including chlorine, such as the addition of chlorine bleach, e.g. sodium hypochlorite. In some embodiments, the cleaning composition includes some trace amount of chlorine, such as a trace amount of chlorine present in one or more of the components.

In various embodiments, the cleaning composition includes chlorine in an amount of from about 0.50 to approaching zero (0), about 0.25 to approaching 0, or about 0.10 to approaching 0, wt. %, each based on 100 parts by weight of the cleaning composition, or any range between the lowest and highest of these values. In certain embodiments, the cleaning composition completely excludes chlorine.

In various embodiments, the cleaning composition is free of a bleach component. While chlorine bleaches tend to be commonly used bleach components, other bleaches include non-chlorine bleaches, such as peroxygen compounds, which release active oxygen in wash water. Further examples of non-chlorine bleaches include perborates/sodium perborates, potassium monopersulfates, sodium percarbonates, hydrogen peroxides, and organic peracids. In various embodiments, the cleaning composition includes the bleach component in an amount of from about 15 to approaching zero (0), about 10 to approaching 0, about 5.0 to approaching 0, or about 1.0 to approaching 0, wt. %, each based on 100 parts by weight of the cleaning composition, or any range between the lowest and highest of these values. In certain embodiments, the cleaning composition completely excludes the bleach component.

### Method of Forming the Cleaning Composition

A method of forming the cleaning composition is also disclosed. The method comprises the step of combining the anionic surfactant and the nonionic surfactant to form a first solution. The surfactants can be combined in various orders, and can be utilized in the amounts described above.

The method further comprises the step of combining the supplemental acid different from the lactic acid with the first solution to form a second solution. The second solution has a pH of no greater than about 5. The supplemental acid, e.g. sulfuric acid, is generally utilized in an amount that lowers the pH of the second solution to no greater than about 5 from an initial pH which is generally greater than 5, e.g. a pH of ˜7+. This is useful for improved economics, in instances where the supplemental acid may be less costly than the lactic acid. In other embodiments, only the lactic acid (rather than the supplemental acid) is utilized in an amount sufficient to obtain the desired level of pH for the cleaning composition, e.g. a pH of about 3.

The method yet further comprises the step of combining the lactic acid and the second solution to form the cleaning composition. The lactic acid is utilized in an amount sufficient to obtain the desired level of pH for the cleaning composition, e.g. a pH of about 3. In this way, the desired level of pH for the cleaning composition can be obtained. Determining proper amounts can be determined via routine experimentation, and will depend on the specific formulation being prepared.

The method may further comprise one of more steps. Such steps can include the addition of one or more of the supplemental components described above. Such components can be added at various times during formation of the cleaning composition. The cleaning composition can be formed utilizing conventional mixing equipment understood in the art.

The following examples, illustrating the cleaning composition of the present invention, are intended to illustrate and not to limit the invention.

### Examples

Comparative and invention cleaning compositions are prepared and evaluated. The cleaning compositions are formed by combining the various components illustrated in Tables I and III below. The cleaning compositions of Table I are considered to be “Mid-tier Performance” cleaning compositions, whereas those in Table III are considered to be “Premium Performance” cleaning compositions.

After formation, the cleaning compositions are evaluated, with results illustrated in Tables II and IV below. Cleaning performance of the various compositions is determined according to ASTM D4009, Method A, Soil B. Viscosity of the various compositions is determined utilizing a Brookfield LV viscometer, spindle #2 (or #62), at 12 RPM. pH of the various compositions is determined utilizing a pH meter. In the various tables below, % actives (% act.) of the compositions is generally based only on the primary surfactants (merely for comparison purposes).

TABLE I

| | Example | | | |
|---|---|---|---|---|
| | Comparative 1 | | Invention 1 | |
| Component | wt. % | % act. | wt. % | % act. |
| Anionic Surfactant 1 | 43.15 | 12.51 | 43.15 | 12.51 |
| Nonionic Surfactant 1 | 25.00 | 12.50 | 25.00 | 12.50 |
| Lactic Acid | 0.00 | — | 2.84 | — |
| Supplemental Acid 1 | 0.00 | — | 1.75 | — |
| Hydrotrope 1 | 3.75 | — | 3.75 | — |
| Diluent 1 | 27.67 | — | 23.51 | — |
| Supplemental Acid 2 | 0.43 | — | 0.00 | — |
| Preservative 1 | q.s. | — | 0.00 | — |
| Fragrance 1 | q.s. | — | 0.00 | — |
| Total | 100 | 25.01 | 100 | 25.01 |

Anionic Surfactant 1 is an anionic surfactant comprising a mixture of sodium alkyl sulfates, mainly the lauryl, i.e., SLS (C10-C16), commercially available from BASF Corporation.

Nonionic Surfactant 1 is a nonionic surfactant, specifically a lauryl/myristyl glucoside consisting of C12, 14, 16 alkyl polyglycoside, commercially available from BASF Corporation. This surfactant is un-preserved, i.e., it does not include a preservative. As such, this surfactant is generally alkaline having a pH of from about 11.5 to about 12.5.

Lactic Acid (80%) is an aqueous solution of 80 wt. % lactic acid, commercially available from Purac.

Supplemental Acid 1 is an aqueous solution of 30 wt. % sulfuric acid.

Hydrotrope 1 is an amphoteric surfactant, specifically a sodium octanoyl sulfate, commercially available from BASF Corporation.

Diluent 1 is (DI) water.

Supplemental Acid 2 is an aqueous solution of 50 wt. % citric acid.

Preservative 1 is optional (in a quantity sufficient), and is a conventional preservative utilized in manual dishwashing compositions.

Fragrance 1 is optional (in a quantity sufficient), and is a conventional fragrance utilized in manual dishwashing compositions.

TABLE II

Example

| | Comparative 1 | Invention 1 |
|---|---|---|
| Plate Test, Soil B | 8.5 | 10 |
| visc (cps @ RT) | 410 | 250 |
| pH | 7.95 | ~2.95 |

The cleaning composition of Invention 1 is at pH of 3.65 prior to additional of the lactic acid. The pH of Invention 1 is averaged over three readings, and is deemed stable over time (>1 month). As shown above in Table II, Invention 1 has superior cleaning power relative to Comparative 1.

TABLE III

| | Example | | | |
|---|---|---|---|---|
| | Comparative 2 | | Invention 2 | |
| Component | wt. % | % act. | wt. % | % act. |
| Anionic Surfactant 1 | 37.93 | 11.00 | 40.00 | 11.60 |
| Nonionic Surfactant 1 | 22.00 | 11.00 | 23.20 | 11.60 |
| Lactic Acid | 0.00 | — | 2.84 | — |
| Supplemental Acid 1 | 0.00 | — | 2.00 | — |
| Hydrotrope 1 | 0.00 | — | 3.50 | — |
| Supplemental Surfactant 1 | 2.20 | 2.20 | 0.00 | — |
| Diluent 1 | 18.90 | — | 21.61 | — |
| Diluent 2 | 6.00 | — | 2.00 | — |
| Supplemental Surfactant 2 | 12.97 | 3.89 | 0.00 | — |
| Supplemental Surfactant 3 | 0.00 | — | 4.85 | 1.79 |
| Supplemental Acid 2 | q.s. | — | 0.00 | — |
| Preservative 1 | 0.00 | — | 0.00 | — |
| Fragrance 1 | 0.00 | — | 0.00 | — |
| Total | 100.00 | 28.09 | 100.00 | 24.99 |

Supplemental Surfactant 1 is a nonionic surfactant, specifically an alkyl polyethylene glycol ether based on C10-Guerbet alcohol and ethylene oxide, commercially available from BASF Corporation.

Diluent 2 is ethanol.

Supplemental Surfactant 2 is a cocamidopropylamine oxide, commercially available from BASF Corporation.

Supplemental Surfactant 3 is an amphoteric surfactant, specifically a cocamidopropyl betaine, commercially available from BASF Corporation.

TABLE IV

Example

| | Comparative 2 | Invention 2 |
|---|---|---|
| Plate Test, Soil B | 11.5 | 13 |
| visc (cps @ RT) | 720 | 995 |
| pH | 7.95 | ~2.99 |

The cleaning composition of Invention 2 is at pH of 3.48 prior to additional of the lactic acid. The pH of Invention 2 is averaged over three readings, and is deemed stable over time (>1 month). As shown above in Table II, Invention 2 has superior cleaning power relative to Comparative 2.

In view of the Comparative 1 and Invention 1 above, it has been surprisingly discovered that a cleaning composition for manual dishwashing formulation containing lactic acid as an antibacterial active at pH=−3, exhibits increased plate count relative to a conventionally equivalent formulation at pH=˜8 containing no lactic acid. In addition, as illustrated above with Comparative 2 and Invention 2, a formulation containing ˜25% active surfactant with lactic acid at pH=˜3 achieves a higher plate count than a similar formulation with higher total surfactant actives (˜28%) without lactic acid.

Additional comparative and invention cleaning compositions are prepared and evaluated. The compositions are formed by combining the various components illustrated in Tables V, VII, and IX below. After formation, the compositions are evaluated, with results illustrated in Tables VI, VIII, and X below.

TABLE V

| | Example | | | |
|---|---|---|---|---|
| | Comparative 3 | | Invention 3 | |
| Component | wt. % | % act. | wt. % | % act. |
| Supplemental Surfactant 4 | 3.00 | — | 3.00 | — |
| Supplemental Surfactant 5 | 38.00 | 21.47 | 38.00 | 21.47 |
| Lactic Acid | 0.00 | — | 2.84 | — |
| Supplemental Acid 2 | 0.00 | — | 0.60 | — |
| Diluent 1 | 59.00 | — | 55.56 | — |
| Total | 100 | 21.47 | 100 | 21.47 |

Supplemental Surfactant 4 is a 40% active, aqueous solution of sodium xylene sulfonate (SXS), commercially available from Huntsman.

Supplemental Surfactant 5 is a mixture of sodium laureth ether sulfate, C12-C16 fatty alcohol (or lauryl) glucoside, and cocamidopropyl betaine, commercially available from BASF Corporation. This surfactant may also be classified as a primary surfactant blend, for purposes of the present invention.

TABLE VI

Example

| | Comparative 3 | Invention 3 |
|---|---|---|
| Plate Test, Soil B | 10.5 | 12 |
| visc (cps @ RT) | 985 | 1215 |
| pH | 6.00 | 2.95 |

The cleaning composition of Invention 3 is at pH of 3.60 prior to additional of the lactic acid. As shown above in Table VI, Invention 3 has superior cleaning power relative to Comparative 3.

TABLE VII

| | Example | | | |
|---|---|---|---|---|
| | Comparative 4 | | Comparative 5 | |
| Component | wt. % | % act. | wt. % | % act. |
| Supplemental Surfactant 6 | 12.00 | 12.60 | 12.00 | 12.60 |
| Supplemental Surfactant 7 | 9.50 | 6.65 | 9.50 | 6.65 |
| Lactic Acid | 0.00 | — | 2.84 | — |
| Base 1 | 3.00 | — | 0.20 | — |
| Diluent 1 | 67.50 | — | 64.66 | — |
| Diluent 2 | 2.00 | — | 2.00 | — |
| Supplemental Surfactant 3 | 6.00 | 2.22 | 6.00 | 2.22 |
| Total | 100.00 | 21.47 | 100.00 | 21.47 |

Supplemental Surfactant 6 is linear alkylbenzene sulfonic (LAS) acid.

Supplemental Surfactant 7 is a sodium lauryl ether sulfate (SLES) with 2 moles EO, commercially available from BASF Corporation.

Base 1 is an aqueous solution of 50 wt. % sodium hydroxide (NaOH).

TABLE VIII

Example

| | Comparative 4 | Comparative 5 |
|---|---|---|
| Plate Test, Soil B | 10 | 10 |
| visc (cps @ RT) | 2690 | 920 |
| pH | 6.55 | 3.0 |

As shown above in Table VI, Comparative 4 and 5 have the same cleaning power.

TABLE IX

| | Example | | | |
|---|---|---|---|---|
| | Comparative 6 | | Invention 5 | |
| Component | wt. % | % act. | wt. % | % act. |
| Supplemental Surfactant 4 | 3.00 | — | 3.00 | — |
| Nonionic Surfactant 1 | 43.00 | 21.50 | 43.00 | 21.50 |
| Lactic Acid | 0.00 | — | 2.84 | — |
| Supplemental Acid 1 | 1.00 | — | 1.10 | — |
| Water | 53.00 | — | 50.06 | — |
| Total | 100 | 21.50 | 100 | 21.50 |

TABLE X

Example

| | Comparative 6 | Invention 5 |
|---|---|---|
| Plate Test, Soil B | 7.0 | 7.5 |
| visc (cps @ RT) | — | — |
| pH | 7.5 | 3.0 |

Viscosities of Comparative 6 and Invention 5 were not recorded.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

1. A cleaning composition for dishwashing, said cleaning composition comprising:
about 1 to about 35 weight percent (wt. %) of an anionic surfactant;
about 1 to about 35 wt. % of a nonionic surfactant; and
at least about 1 wt. % of lactic acid;
wherein said anionic and nonionic surfactants are present in a combined amount of at least about 8 wt. %, each of the weight percentages is based on 100 parts by weight of said cleaning composition, and said cleaning composition has a pH of no greater than about 4.

2. The cleaning composition as set forth in claim 1, having a pH of no greater than about 3.5.

3. The cleaning composition as set forth in claim 1, having a pH of about 3.

4. The cleaning composition as set forth in claim 1, wherein said anionic surfactant is a fatty alcohol sulfate (FAS).

5. The cleaning composition as set forth in claim 1, wherein said anionic surfactant is present in an amount of from about 10 to about 15 wt. % based on 100 parts by weight of said cleaning composition.

6. The cleaning composition as set forth in claim 1, wherein said anionic surfactant is a sodium lauryl sulfate (SLS).

7. The cleaning composition as set forth in claim 1, wherein said nonionic surfactant is an alkyl polyglycoside (APG).

8. The cleaning composition as set forth in any one of the claim 1, wherein said nonionic surfactant is present in an amount of from about 10 to about 15 wt. % based on 100 parts by weight of said cleaning composition.

9. The cleaning composition as set forth in claim 1, wherein said lactic acid is present in an amount of from about 2 to about 5 wt. % based on 100 parts by weight of said cleaning composition.

10. The cleaning composition as set forth in claim 1, further comprising water in an amount of from about 40 to about 90 parts per weight based on 100 parts by weight of said cleaning composition.

11. The cleaning composition as set forth in claim 1, further comprising a second anionic surfactant different from said anionic surfactant.

12. The cleaning composition as set forth in claim 11, wherein said second anionic surfactant is:
i) present in an amount of from about 1 to about 10 parts by weight based on 100 parts by weight of said cleaning composition;
ii) a sodium alkyl sulfate; or
iii) both i) and ii).

13. The cleaning composition as set forth in claim 1, further comprising an alcohol and wherein said alcohol is:
i) present in an amount of from about 1 to about 10 parts by weight based on 100 parts by weight of said cleaning composition;
ii) ethanol; or
iii) both i) and ii).

14. The cleaning composition as set forth in claim 1, further comprising a supplemental surfactant different from said nonionic and anionic surfactants.

15. The cleaning composition as set forth in claim 14, wherein said supplemental surfactant is:
i) selected from the group of betaines, amine oxides, or combinations thereof;
ii) present in an amount of from about 1 to about 10 parts by weight based on 100 parts by weight of said cleaning composition; or
iii) both i) and ii).

16. The cleaning composition as set forth in preceding claim 1, further comprising a supplemental acid different from said lactic acid.

17. The cleaning composition as set forth in claim 1, having a viscosity of from about 100 to about 5000 millipascal-second (mPa·s) at 23° C.

18. The cleaning composition as set forth in claim 1, free of an antibacterial component.

19. A cleaning composition for dishwashing, said cleaning composition comprising:
about 5 to about 20 weight percent (wt. %) of a sodium lauryl sulfate (SLS);
about 5 to about 20 wt. % of an alkyl polyglycoside (APG); and
about 2 to about 5 wt. % of lactic acid;
wherein each of the weight percentages is based on 100 parts by weight of said cleaning composition; and
wherein said cleaning composition has a pH of no greater than about 4, a viscosity of from about 100 to about 5000 millipascal-second (mPa·s) at 23° C., and is free of an antibacterial component.

20. A method of forming a cleaning composition for dishwashing with the cleaning composition comprising an anionic surfactant, a nonionic surfactant, lactic acid, and a supplemental acid different from the lactic acid, said method comprising the steps of:
combining the anionic surfactant and the nonionic surfactant to form a first solution;
combining the supplemental acid different from the lactic acid with the first solution to form a second solution with the second solution having a pH of no greater than about 5; and
combining the lactic acid and the second solution to form the cleaning composition;
wherein the cleaning composition has a pH of no greater than about 4.
